(19) United States
(12) Patent Application Publication
(10) Pub. No.: US 2026/0270918 A1
(43) Pub. Date: Sep. 10, 2026

(54) METHOD AND APPARATUS FOR T3502 HANDLING OF ONBOARDING SERVICES IN WIRELESS COMMUNICATIONS

(71) Applicant: Media Tek Singapore Pte. Ltd., Singapore (SG)

(72) Inventors: Puneet PUNEET, Bengaluru (IN); Yuan-Chieh LIN, Hsinchu City (TW)

(21) Appl. No.: 19/165,888

(22) PCT Filed: May 10, 2024
(86) PCT No.: PCT/CN2024/092264

§ 371 Date: Sep. 16, 2025

(30) Foreign Application Priority Data
May 10, 2023 (IN) 202321033076

(51) Int. Cl. H04W 60/04; H04W 8/22; H04W 48/18; H04W 84/04

(52) U.S. Cl. CPC H04W 60/04; H04W 8/22; H04W 48/18; H04W 84/042

(57) ABSTRACT

Solutions pertaining to T3502 timer handling of onboarding services in wireless communications are proposed. In response to a predefined condition existing, an apparatus (e.g., a user equipment (UE)) disables a specific capability for a network access, stores an identity of a public land mobile network (PLMN) or standalone non-public network (SNPN), where the specific capability for the network access has been disabled and starts a timer with respect to re-enabling the specific capability for the network access. Moreover, the apparatus removes the identity of the PLMN or SNPN from the stored identities of PLMNs or SNPNs where the specific capability for the network access has been disabled upon expiry of the timer. Alternatively, the apparatus triggers a PLMN selection, an SNPN selection, or an SNPN selection for onboarding services, while keeping the specific capability disabled during the selection.

### CROSS REFERENCE TO RELATED PATENT APPLICATION(S)

The present disclosure is part of a non-provisional application claiming the priority benefit of Indian Patent Application number 202321033076, filed 10 May 2023, the content of which herein being incorporated by reference in its entirety.

### TECHNICAL FIELD

The present disclosure is generally related to mobile communications and, more particularly, to techniques for T3502 timer handling of onboarding services in wireless communications.

### BACKGROUND

Under the current 3^{rd} Generation Partnership Project (3GPP) specification, onboarding services in a standalone non-public network (SNPN) allows a mobile station (MS) to access an SNPN indicating that onboarding is allowed, using default user equipment (UE) credentials for primary authentication in order for the MS to be configured with one or more entries of the “list of subscriber data.” When an initial registration or a mobility registration update procedure for onboarding services fails due to an abnormal situation such as, for example, expiry of T3510 timer, lower-layer failure, or the like, while the UE registration attempt counter reaches 5, the UE is to start its T3502 timer. For instance, when a UE is performing an initial registration for onboarding services in an SNPN or when the UE is registered for onboarding services in the SNPN and is performing a mobility registration update procedure in the SNPN, when the initial registration or mobility registration update procedure for onboarding services fails due to an abnormal situation while the UE registration attempt counter reaches 5, then the UE may enter the state of either 5GMM-DEREGISTERED.PLMN-SEARCH or 5GMM-REGISTERED.PLMN-SEARCH and may also perform an SNPN selection or an SNPN selection for onboarding services. Moreover, the UE is to start its T3502 timer.

If the UE changes the state to PLMN-SEARCH state, then the UE can camp on the same SNPN where the T3502 timer is running or a different SNPN. If the UE camps on a different SNPN, then T3502 would be stopped. If the UE's initial registration or mobility registration update procedure is failed due to abnormal situations like T3510 expiry, lower-layer failure or another reason while the UE's registration attempt counter reaches 5 on the different SNPN, then the UE would change the state to PLMN-SEARCH state and the UE can camp on the same SNPN where T3502 is running or a different SNPN, thereby resulting in the UE being stuck in a loop from which the UE cannot escape. Currently there is no mechanism to avoid this loop. Therefore, there is a need for a solution on T3502 timer handling of onboarding services in wireless communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to T3502 timer handling of onboarding services in wireless communications.

In one aspect, a method may include a UE, responsive to a predefined condition existing, performing operations including: (1) disabling a specific capability for a network access; (2) storing an identity of a public land mobile network (PLMN) or standalone non-public network (SNPN), where the specific capability for the network access has been disabled; and (3) starting a timer with respect to re-enabling the specific capability for the network access. The method may also involve the UE removing the identity of the PLMN or SNPN from the stored identities of PLMNs or SNPNs where the specific capability for the network access has been disabled upon expiry of the timer.

In another aspect, a method may include a UE, responsive to a predefined condition existing, performing operations including: (1) disabling a specific capability for a network access; (2) storing an identity of a public land mobile network (PLMN) or standalone non-public network (SNPN), where the specific capability for the network access has been disabled; and (3) starting a timer with respect to re-enabling the specific capability for the network access. The method may also involve the UE triggering a PLMN selection, an SNPN selection, or an SNPN selection for onboarding services. The method may further involve the UE keeping the specific capability disabled when performing the PLMN selection, the SNPN selection, or the SNPN selection for onboarding services.

It is noteworthy that, although the description provided herein may be in the context of certain radio access technologies, networks, and network topologies such as 5th Generation (5G), New Radio (NR) or Beyond 5th Generation (B5G) mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a first example process in accordance with an implementation of the present disclosure.

FIG. 4 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to T3502 timer handling of onboarding services in wireless communications. According to the present disclosure, a number of possible solutions may be implemented separately or jointly. That is, although these possible solutions may be described below separately, two or more of these possible solutions may be implemented in one combination or another.

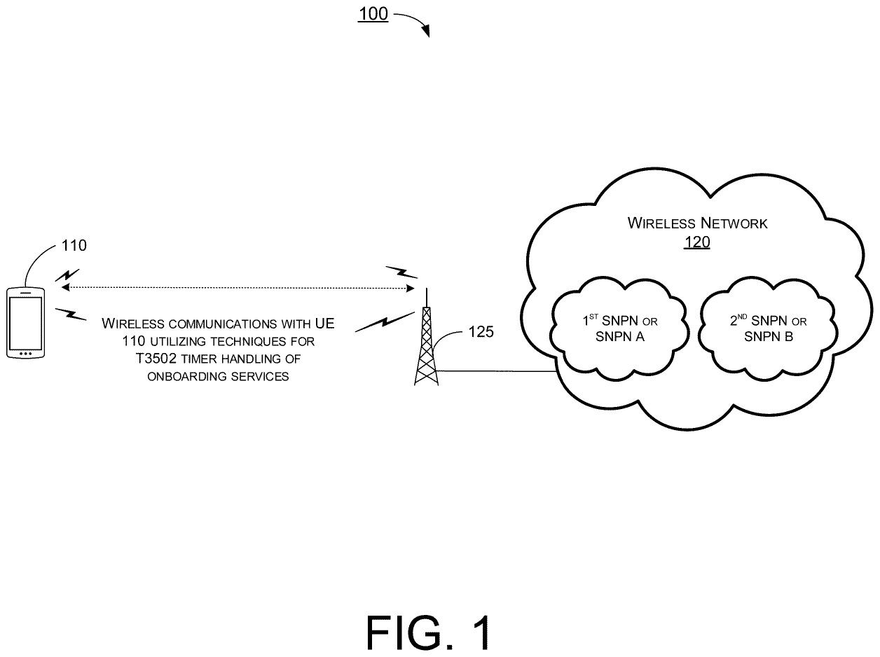

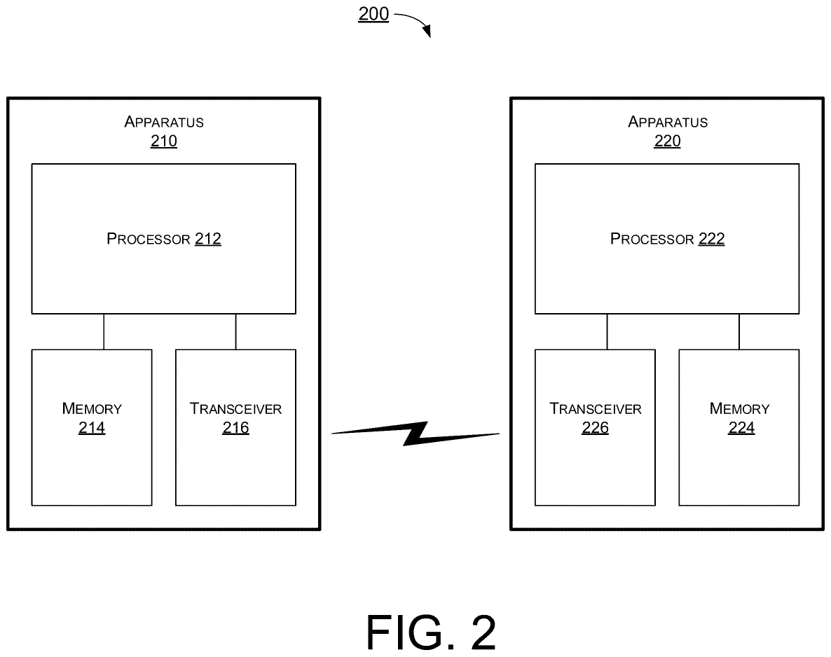

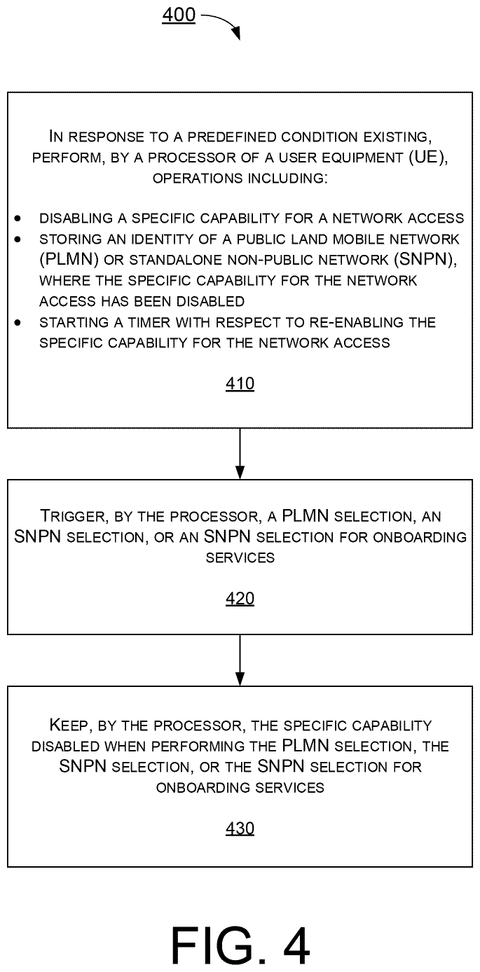

FIG. 1 illustrates an example network environment 100 in which various solutions and schemes in accordance with the present disclosure may be implemented. FIG. 2~FIG. 4 illustrate examples of implementation of various proposed schemes in network environment 100 in accordance with the present disclosure. The following description of various proposed schemes is provided with reference to FIG. 1~FIG. 4.

Referring to FIG. 1, network environment 100 may involve a UE 110 in wireless communication with a wireless network 120 (e.g., a 5G NR mobile network) as part of a communication network. Wireless network 120 may include a first SNPN and a second SNPN (herein interchangeably referred to as “SNPN A” and “SNPN B”, respectively). UE 110 may initially be in wireless communication with wireless network 120 via a base station or network node 125 (e.g., an eNB, gNB or transmit-receive point (TRP)). In network environment 100, UE 110 and wireless network 120 may implement various schemes pertaining to T3502 timer handling of onboarding services in wireless communications in accordance with the present disclosure, as described herein.

As used herein, a lower layer may refer to a layer in the 5th Generation Mobility Management (5GMM) protocol stack that is lower than the RRC layer, such as a packet data convergence protocol (PDCP) layer, a radio control link (RLC) layer, a medium access control (MAC) layer, a physical (PHY) layer, and so forth. It is noteworthy that the unequal modulation (UEQM) in the various proposed schemes may be in the frequency domain and/or the spatial domain. It is also noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

When UE 110 performs an initial registration for onboarding services on SNPN A and the registration fails due to an abnormal situation (e.g., T3510 expiry, lower-layer failure or another reason) and the registration attempt counter of UE 110 reaches 5 on SNPN A, a first T3502 (if running) may be stopped by UE 110 upon SNPN change. UE 110 may start a second T3502 and perform an SNPN selection procedure for onboarding services. When UE 110 finds SNPN B and starts an initial registration for onboarding services on SNPN B, the second T3502 (if running) may be stopped upon SNPN change. In case the initial registration for onboarding services fails due to an abnormal situation (e.g., T3510 expiry, lower-layer failure or another reason) while the registration attempt counter of UE 110 reaches 5 on SNPN B, UE 110 may start a third T3502 and perform another SNPN selection procedure for onboarding services. The aforementioned operations may be repeated in a loop and UE 110 may be stuck in the loop of registration, thereby overloading signaling in wireless network 120 since T3502 is applicable for the selected SNPN.

Under a proposed scheme in accordance with the present disclosure, UE 110 may disable an N1 mode capability for an SNPN on which UE 110 is currently camped over a 3GPP access in case that an initial registration or mobility registration update procedure for onboarding services fails due to an abnormal situation (e.g., T3510 expiry, lower-layer failure or another reason) and that the registration attempt counter of UE 110 reaches 5. UE 110 may memorize (e.g., store in a list) the identities of one or more SNPNs where the N1 mode capability for 3GPP access was/has been disabled. As defined in 3GPP, “N1 mode” refers to a mode in which a UE (e.g., UE 110) is allowed access to a 5G core network via a 5G radio access network (RAN).

As an implementational option, UE 110 may start a timer for enabling N1 mode capability for the 3GPP access. That is, upon expiry of this timer, UE 110 may enable the N1 mode capability for the 3GPP access. It may be recommendable that the value of such a timer for re-enabling N1 mode capability is the same as the value of T3502. In case that the value of T3502 is indicated as zero or deactivated by wireless network 120, an implementation-specific non-zero value may be used by UE 110 for such a timer for re-enabling N1 mode capability.

Under another proposed scheme in accordance with the present disclosure, when an initial registration or mobility registration update procedure for onboarding services fails due to an abnormal situation (e.g., T3510 expiry, lower-layer failure or another reason) while the registration attempt counter of UE 110 reaches 5 by a first SNPN (e.g., SNPN A) plus one or more conditions among a plurality of conditions, then UE 110 may keep a first T3502 running and, optionally, associate the first T3502 with the first SNPN. Optionally, UE 110 may not consider the first SNPN while the first T3502 is running in an SNPN selection procedure for onboarding services. The plurality of conditions may include, for example and not limited to: (1) UE 110 performing an SNPN selection mode for onboarding services; (2) UE 110 starting the first T3502; (3) UE 110 performing the SNPN selection procedure for onboarding services; (4) UE 110 selecting a second SNPN (e.g., SNPN B) for onboarding services; and (5) UE 110 initiating a registration procedure to register to the second SNPN.

In view of the above, certain features of the various proposed schemes in accordance with the present disclosure may be summarized below.

In one aspect, UE 110 may, in response to a predefined condition existing, perform certain operations, including: (1) disabling a specific capability for a network access; (2) storing in a list an identity of a public land mobile network (PLMN) or SNPN, with the list containing identifies of PLMNs or SNPNs where the specific capability for the network access has been disabled; and (3) starting a timer with respect to re-enabling the specific capability for the network access. Moreover, UE 110 may remove the identity of the PLMN or SNPN from the list upon expiry of the timer.

In some implementations, the predefined condition may include a failure of a registration procedure for an initial registration for onboarding services while a registration attempt counter of the UE reaches 5.

In some implementations, the predefined condition may include a failure of a mobility registration update procedure for onboarding services while a registration attempt counter of the UE reaches 5.

In some implementations, the specific capability may include an N1 mode capability for a 3GPP access.

In another aspect, UE 110 may, in response to a predefined condition existing, perform certain operations, including: (1) disabling a specific capability for a network access; (2) storing in a list an identity of a PLMN or SNPN, with the list containing identifies of PLMNs or SNPNs where the specific capability for the network access has been disabled; and (3) starting a timer with respect to re-enabling the specific capability for the network access. UE 110 may trigger a PLMN selection, an SNPN selection, or an SNPN selection for onboarding services. Furthermore, UE 110 may keep the specific capability disabled when performing the PLMN selection, the SNPN selection, or the SNPN selection for onboarding services.

In some implementations, in triggering, UE 110 may enter either a 5GMM-DEREGISTERED.PLMN-SEARCH or a 5GMM-REGISTERED.PLMN-SEARCH state so as to trigger the PLMN selection, the SNPN selection, or the SNPN selection for onboarding services.

In some implementations, the predefined condition may include a failure of a registration procedure for an initial registration for onboarding services while a registration attempt counter of the UE reaches 5.

In some implementations, the predefined condition may include a failure of a mobility registration update procedure for onboarding services while a registration attempt counter of the UE reaches 5.

In some implementations, the specific capability may include an N1 mode capability for a 3GPP access.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to T3502 timer handling of onboarding services in wireless communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to T3502 timer handling of onboarding services in wireless communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

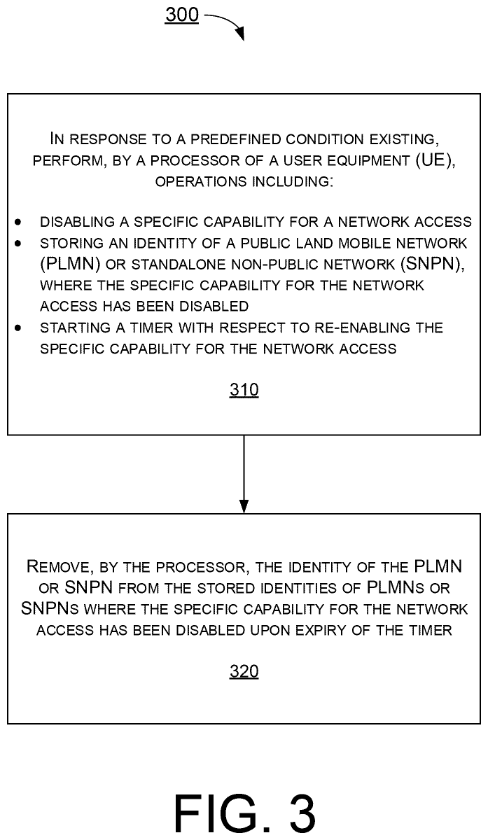

FIG. 3 illustrates an example process 300 in accordance with an implementation of the present disclosure. Process 300 may represent an aspect of implementing various proposed designs, concepts, schemes, systems, and methods described above, whether partially or entirely, including those pertaining to those described above. More specifically, process 300 may represent an aspect of the proposed concepts and schemes pertaining to T3502 timer handling of onboarding services in wireless communications. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210, responsive to a predefined condition existing, performing operations including: (1) disabling a specific capability for a network access; (2) storing (e.g., in memory 214) an identity of a PLMN or SNPN, where the specific capability for the network access has been disabled; and (3) starting a timer with respect to re-enabling the specific capability for the network access. Process 300 may proceed from 310 to 320.

At 320, process 300 may involve processor 212 removing the identity of the PLMN or SNPN from the stored identities of PLMNs or SNPNs where the specific capability for the network access has been disabled upon expiry of the timer.

In some implementations, the predefined condition may include a failure of a registration procedure for an initial registration for onboarding services while a registration attempt counter of the UE reaches 5.

In some implementations, the predefined condition may include a failure of a mobility registration update procedure for onboarding services while a registration attempt counter of the UE reaches 5.

In some implementations, the specific capability may include an N1 mode capability for a 3GPP access.

FIG. 4 illustrates an example process 400 in accordance with an implementation of the present disclosure. Process 400 may represent an aspect of implementing various proposed designs, concepts, schemes, systems, and methods described above, whether partially or entirely, including those pertaining to those described above. More specifically, process 400 may represent an aspect of the proposed concepts and schemes pertaining to T3502 timer handling of onboarding services in wireless communications. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210, responsive to a predefined condition existing, performing operations including: (1) disabling a specific capability for a network access; (2) storing (e.g., in memory 214) an identity of a PLMN or SNPN, where the specific capability for the network access has been disabled; and (3) starting a timer with respect to re-enabling the specific capability for the network access. Process 400 may proceed from 410 to 420.

At 420, process 400 may involve processor 212 triggering a PLMN selection, an SNPN selection, or an SNPN selection for onboarding services. Process 400 may proceed from 420 to 430.

At 430, process 400 may involve processor 212 keeping the specific capability disabled when performing the PLMN selection, the SNPN selection, or the SNPN selection for onboarding services.

In some implementations, in triggering, process 400 may involve processor 212 entering a PLMN-SEARCH state or an ATTEMPTING-REGISTRATION state so as to trigger the PLMN selection, the SNPN selection, or the SNPN selection for onboarding services.

In some implementations, the predefined condition may include a failure of a registration procedure for an initial registration for onboarding services while a registration attempt counter of the UE reaches 5.

In some implementations, the predefined condition may include a failure of a mobility registration update procedure for onboarding services while a registration attempt counter of the UE reaches 5.

In some implementations, the specific capability may include an N1 mode capability for a 3GPP access.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a user equipment (UE), operations responsive to a predefined condition existing, the operations comprising:
disabling a specific capability for a network access;
storing an identity of a public land mobile network (PLMN) or standalone non-public network (SNPN), where the specific capability for the network access has been disabled; and
starting a timer with respect to re-enabling the specific capability for the network access; and
removing, by the processor, the identity of the PLMN or SNPN from the stored identities of PLMNs or SNPNs where the specific capability for the network access has been disabled upon expiry of the timer.

2. The method of claim 1, wherein the predefined condition comprises a failure of a registration procedure for an initial registration for onboarding services while a registration attempt counter of the UE reaches 5.

3. The method of claim 1, wherein the predefined condition comprises a failure of a mobility registration update procedure for onboarding services while a registration attempt counter of the UE reaches 5.

4. The method of claim 1, wherein the specific capability comprises an N1 mode capability for a 3^{rd} Generation Partnership Project (3GPP) access.

5. A method, comprising:
performing, by a processor of a user equipment (UE), operations responsive to a predefined condition existing, the operations comprising:
disabling a specific capability for a network access;
storing an identity of a public land mobile network (PLMN) or standalone non-public network (SNPN), where the specific capability for the network access has been disabled; and
starting a timer with respect to re-enabling the specific capability for the network access;
triggering, by the processor, a PLMN selection, an SNPN selection, or an SNPN selection for onboarding services; and
keeping, by the processor, the specific capability disabled when performing the PLMN selection, the SNPN selection, or the SNPN selection for onboarding services.

6. The method of claim 5, wherein the triggering comprises entering a PLMN-SEARCH state or an ATTEMPTING-REGISTRATION state to trigger the PLMN selection, the SNPN selection, or the SNPN selection for onboarding services.

7. The method of claim 5, wherein the predefined condition comprises a failure of a registration procedure for an initial registration for onboarding services while a registration attempt counter of the UE reaches 5.

8. The method of claim 5, wherein the predefined condition comprises a failure of a mobility registration update procedure for onboarding services while a registration attempt counter of the UE reaches 5.

9. The method of claim 5, wherein the specific capability comprises an N1 mode capability for a 3^{rd} Generation Partnership Project (3GPP) access.

10. An apparatus implementable in a user equipment (UE), comprising:
a transceiver configured to communicate wirelessly; and
a processor coupled to the transceiver and configured to execute operations comprising:
performing, via the transceiver, operations responsive to a predefined condition existing, the operations comprising:
disabling a specific capability for a network access;
storing an identity of a public land mobile network (PLMN) or standalone non-public network (SNPN), where the specific capability for the network access has been disabled; and
starting a timer with respect to re-enabling the specific capability for the network access.

11. The apparatus of claim 10, wherein the processor is further configured to perform operations comprising:
removing the identity of the PLMN or SNPN from the stored identities of PLMNs or SNPNs where the specific capability for the network access has been disabled upon expiry of the timer.

12. The apparatus of claim 10, wherein the processor is further configured to perform operations comprising:
triggering a PLMN selection, an SNPN selection, or an SNPN selection for onboarding services; and
keeping the specific capability for network access disabled when performing the PLMN selection, the SNPN selection, or the SNPN selection for onboarding services.

13. The apparatus of claim 12, wherein the triggering comprises entering an ATTEMPTING-REGISTRATION state or a PLMN-SEARCH state to trigger the PLMN selection, the SNPN selection, or the SNPN selection for onboarding services.

14. The apparatus of claim 10, wherein the predefined condition comprises a failure of a registration procedure for an initial registration for onboarding services while a registration attempt counter of the UE reaches 5.

15. The apparatus of claim 10, wherein the predefined condition comprises a failure of a mobility registration update procedure for onboarding services while a registration attempt counter of the UE reaches 5.

16. The apparatus of claim 10, wherein the specific capability for network access comprises an N1 mode capability for a 3^{rd} Generation Partnership Project (3GPP) access.
